(19) United States
(12) Patent Application Publication
(10) Pub. No.: US 2026/0114383 A1
(43) Pub. Date: Apr. 30, 2026

(54) PLANTER TRANSPORT TRAY HAVING REMOVAL MEANS

(71) Applicant: Lucy A. MITCHELL, Wiltshire (GB)

(72) Inventor: Lucy A. MITCHELL, Wiltshire (GB)

(21) Appl. No.: 19/368,366

(22) Filed: Oct. 24, 2025

Related U.S. Application Data
(60) Provisional application No. 63/711,997, filed on Oct. 25, 2024.

(51) Int. Cl. A01G 9/029

(52) U.S. Cl. CPC A01G 9/0299; A01G 9/0297

(57) ABSTRACT

A planter transport tray including a top face and a bottom face, a plurality of cavities disposed within the top face and protruding from the bottom face, each of the plurality of cavities forming a planter cavity, the planter cavity having a floor with one or more drainage apertures therein, a plurality of channels disposed within the top face and protruding from the bottom face, each channel of the plurality of channels connected between two adjacent planter cavities, and one or more protrusions disposed within the bottom face and protruding from the top face, where each planter cavity is adapted to accept a single plant planter therein, the single plant planter having a central aperture, the one or more protrusions configured to be inserted into the central aperture of the single plant planter thereby dislodging contents therein away from the central aperture for removal.

### CROSS-REFERENCE TO RELATED APPLICATIONS

This application claims priority pursuant to 35 U.S.C. 119(e) to U.S. Patent Application No. 63/711,997, filed Oct. 25, 2024, which application is incorporated herein by reference in its entirety.

### FIELD

The present invention relates to planters for potted plants, specifically to transportation trays that hold a plurality of individual planters therein.

### BACKGROUND

Single pot planters and seedling planters are common tools used to grow indoor and outdoor plants. Traditionally, a planting pot has a single container that holds a single plant, whereas a seedling tray planter has a single container with various compartments that holds multiple individual seedlings within the compartments or may hold a plurality of single pot planters-allowing the tray to be used to transport multiple single pot planters.

Planting, or repotting plants is essential to keep plants vibrant and growing, as the plants or seedlings are growth restricted within a single pot planter. Young plants are often repotted for the purpose of transferring the plant to a permanent planting bed or pot. Other plants must be repotted at least once or twice per year to keep the plant healthy. A problem with traditional planters is that they do not allow for the easy and safe transfer of plants.

Typically, a single pot planter must be turned on its side, e.g., at least 900 or even upside down to loosen the plant away from the sides and floor of the pot. Soil is usually lost during this turning or inversion which can have a negative effect on plant viability. The loose soil is very difficult to keep in place when attempting to re-pot a plant or re-plant a plant into a flower bed. Additionally, it is common for fertilizer and other additives to be placed on top of the soil in the planter and typically fall out when the planter is tilted or inverted.

To loosen the plant away from a planter, for planting or re-potting, the portion of the pot the plant is secured into is squeezed from the sides and the bottom, and the plant is pulled out from the top to lift it away from the pot. This process causes damage to the plant and the roots. To remove plants from non-flexible planters, an additional tool, such as a hand shovel is needed to remove the plant from the pot. The use of the hand tool can result in damage to the roots. The removal of larger plants or shrubs is especially difficult under these conditions, and typically involves cutting the plant out of the temporary plastic container because of its weight. This process not only has the ability to damage the roots of the plant, but it can also harm the user removing the plant. Additionally, removing any plant or shrub from traditional planters is difficult and takes up a large amount of time. Plants in distress often die shortly after repotting which wastes more time and money.

Furthermore, conventional plant removal techniques often require specific knowledge about the type of plant being handled, such as where to grip the plant to avoid damage to delicate stems or leaves, or how much force to apply to the pot. This necessity for specialized judgment makes such tasks difficult to automate and prone to human error, particularly in large-scale operations. The delicate nature of plants means that improper handling can easily lead to breakage, bruising, or other damage, further contributing to plant loss, reduced productivity, and additional costs.

Therefore, there is a long-felt need for a planter transport tray, which holds a plurality of single plant planters therein, is stackable with like planter transport trays, and also includes a mechanism, e.g., a protrusion, that can be used with a single plant planter that releases the root ball (e.g., the soil and roots of the plant) from the bottom floor and inner sides of the planter, allowing the plant to be removed without tilting or inverting the single plant planter.

### SUMMARY

The various concepts of the planter transport tray, disclosed herein, address the long-standing problems associated with the conventional removal of plants from individual planters, which often leads to root damage, soil loss, and user inconvenience. The primary goal of this invention is to provide a system that enables the gentle, efficient, and non-damaging removal of a plant and its root ball from a single plant planter, specifically by facilitating the dislodgement of the plant's contents without requiring manipulation of the planter itself.

The described planter transport tray and associated method offer substantial advantages over existing solutions. The integrated design not only facilitates efficient transport and organized watering of multiple plants but also provides a needed non-damaging mechanism for extracting plants from their individual containers. This significantly reduces labor, prevents damage to sensitive root systems, minimizes soil loss, and ultimately leads to healthier plants and a more streamlined repotting process for users. The use of distinct removal protrusions on the tray's surface, separate from the holding cavities, provides a dedicated and stable platform for the dislodging action. Furthermore, the fluidly connected channels contribute to improved plant health during storage by ensuring even moisture distribution, preventing both over- and under-watering. The stackable nature of the trays further enhances practicality for commercial and domestic use. The system, device, and method collectively simplify the plant removal procedure for human workers, mechanical devices, or fully robotic machines, thereby improving productivity substantially and reducing overall labor costs in warehouse or wholesale applications.

According to aspects herein, the present invention generally comprises a planter transport tray, the tray including a top face and a bottom face, a plurality of cavities disposed within the top face and protruding from the bottom face, each of the plurality of cavities forming a planter cavity, the planter cavity having a floor with one or more drainage apertures therein, a plurality of channels disposed within the top face and protruding from the bottom face, each channel of the plurality of channels connected between two adjacent planter cavities, and one or more protrusions disposed within the bottom face and protruding from the top face, wherein each planter cavity is adapted to accept a single plant planter therein, the single plant planter having a central aperture, the one or more protrusions configured to be inserted into the central aperture of the single plant planter thereby dislodging contents therein away from the central aperture for removal.

In some embodiments, the plurality of channels fluidly connects the plurality of cavities.

In one possible configuration, each of the plurality of cavities is cylindrical.

In another possible configuration the one or more protrusions are cylindrical.

In some embodiments, the tray may further comprise a lip circumscribing an edge of the tray and extending distally therefrom.

In some arrangements, the tray may further comprise a central protrusion arranged within the floor of each planter cavity, the central protrusion arranged to be at least partially inserted within the center aperture of the single plant planter when the single plant planter is seated within the planter cavity.

In some configurations, each channel of the plurality of channels has a floor, the floor each channel of the plurality of channels being integrally connected to the floors of a pair of adjacent planter cavities.

In other configurations, the floor of the planter cavity includes a plurality of arcuate depressions circumscribing the central protrusion and protruding from the floor, wherein the one or more drainage apertures are arranged between a pair of arcuate depressions of the plurality of arcuate depressions.

In a further possible configuration, each of the plurality of cavities is frustoconical.

In an even further possible configuration the one or more protrusions are frustoconical.

In some embodiments, the lip is angled in a direction away from the plurality of cavities.

In some arrangements, the one or more protrusions forms a protrusion cavity within the bottom face.

In one possible embodiment, the aforementioned planter transport tray is configured with one less channel of the plurality of channel than the plurality of cavities.

In other embodiments, the plurality of channels fluidly connects the plurality of cavities in a serpentine pattern.

In further embodiments, the plurality of cavities includes a pair of end planter cavities, each of the pair of end planter cavities is fluidly connected to a single channel of the plurality of channels.

In some configurations, some of the plurality of cavities are connecting planter cavities, each of the connecting planter cavities is fluidly connected to a pair of channels of the plurality of channels.

In another aspect, the present invention may related to a method for transporting single plant planters, the method having the steps of: providing a tray with a plurality of planter cavities therein, each adjacent planter cavity of the plurality of planter cavities being fluidly connected by one or more channels; configuring each planter cavity of the plurality of planter cavities to accept a single plant planter therein; and, providing one or more protrusions that extend from the tray in an opposite direction of the plurality of planter cavities, wherein the one or more protrusions are adapted to be inserted within a central aperture of the single plant planter, thereby dislodging contents within the single plant planter.

The aforementioned method may also include the step of arranging the plurality of cavities and the one or more channels in a serpentine configuration within the tray.

In a further aspect, the a plant container handling system is contemplated, which system may include a tray body having a top surface and a bottom surface, a plurality of distinct container receiving portions integrally formed with the tray body, each container receiving portion configured to individually hold a plant container, and at least one dislodging protrusion extending from the top surface of the tray body, wherein the at least one dislodging protrusion is configured to be inserted into an aperture of a plant container when the plant container is positioned over the dislodging protrusion, thereby at least partially displacing contents within the plant container away from its base.

In the aforementioned system, each of the plurality of distinct container receiving portions may be fluidly connected to another container receiving portion of the plurality of distinct container receiving portions by one or more channels.

The plant container handling system and method described herein offer significant advantages by ensuring the plant remains upright throughout the entire removal process, eliminating the need for plant-specific handling knowledge. This design allows for universal application, regardless of plant type, and fundamentally simplifies the task of plant extraction. Consequently, the system is ideally suited for automation, enabling automated machines or robotic systems to safely and efficiently handle plant removal without complex programming for delicate plant parts. This capability directly translates into substantial reductions in labor costs and dramatic improvements in productivity, particularly in high-volume horticultural operations such as warehouses and wholesale nurseries

These and other objects, features, and advantages of the present invention will become readily apparent upon a review of the following detailed description of the present invention, in view of the drawings and appended claims.

### BRIEF DESCRIPTION

Various embodiments are disclosed, by way of example only, with reference to the accompanying schematic drawings in which corresponding reference symbols indicate corresponding parts, in which:

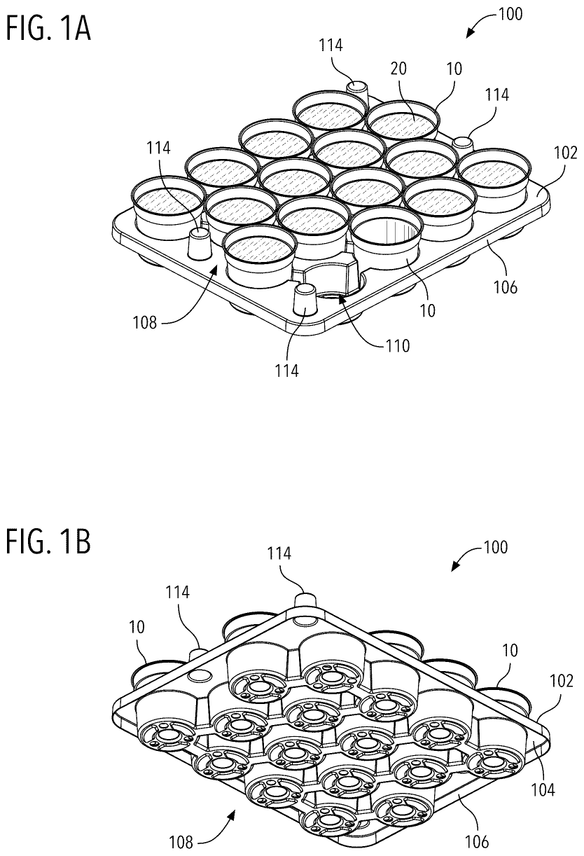

FIGS. 1A and 1B generally show perspective views of a planter transport tray having a plurality of single plant planters therein;

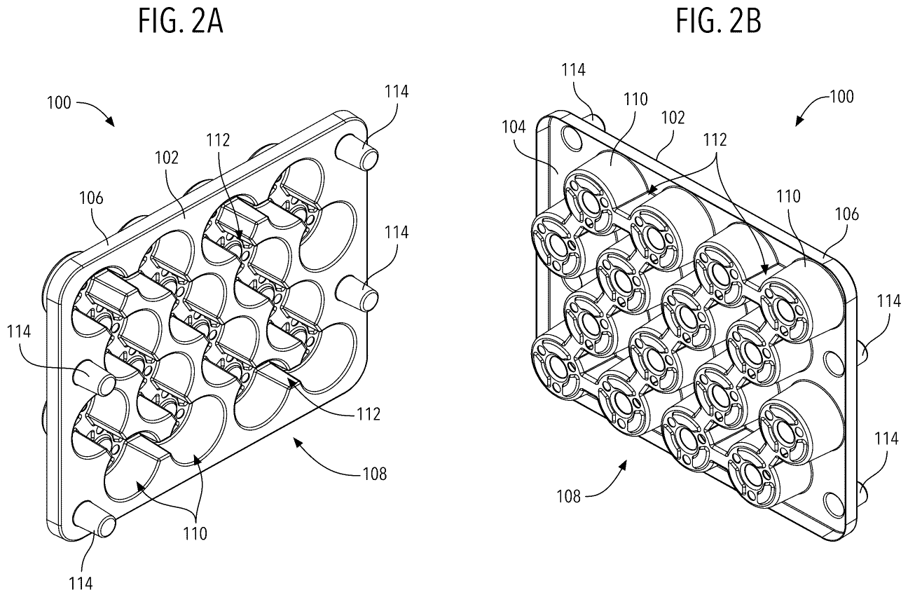

FIGS. 2A and 2B generally show perspective views of the planter transport tray shown in FIGS. 1A and 1B;

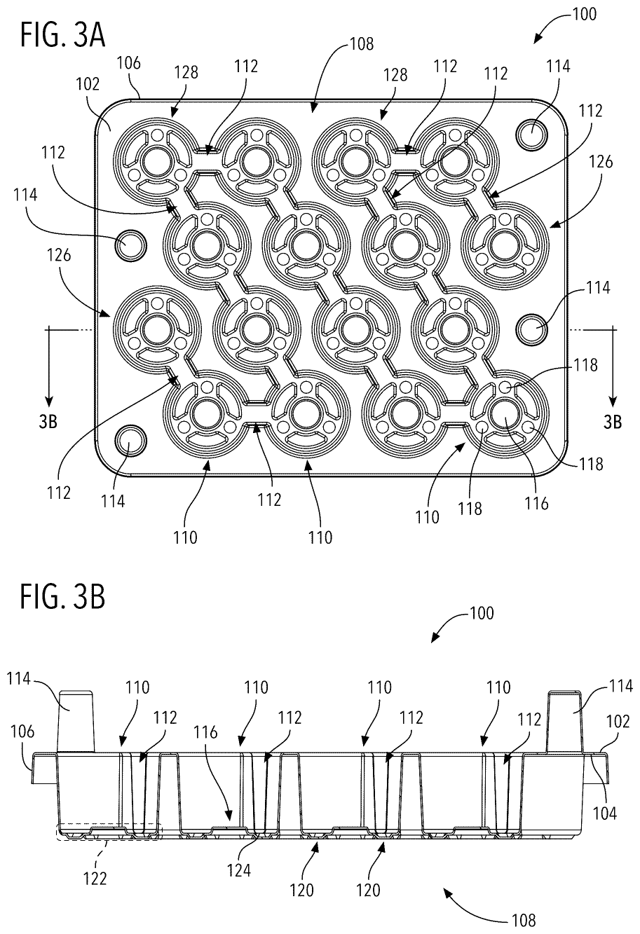

FIG. 3A generally illustrates a top view of the tray shown in FIG. 2A;

FIG. 3B is a cross-sectional view taken generally along line 3B-3B in FIG. 3A;

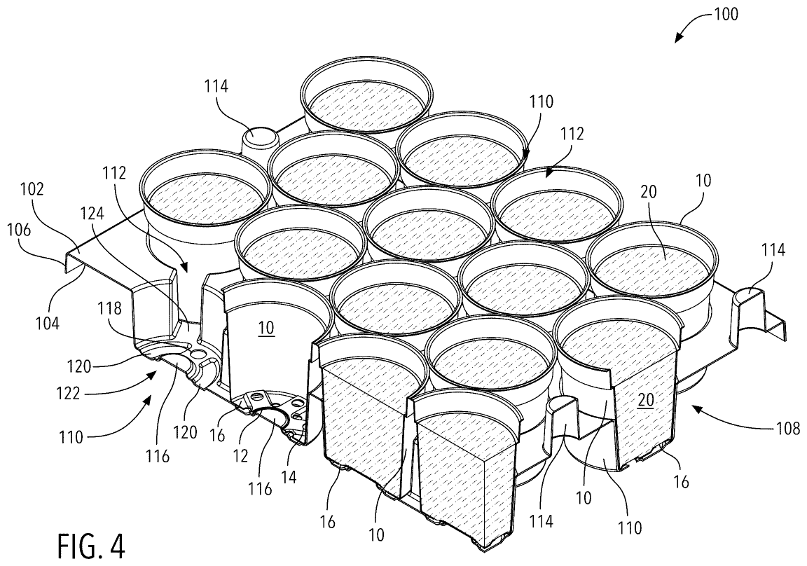

FIG. 4 is a perspective view of the tray shown in FIG. 1A having portions thereof cutaway;

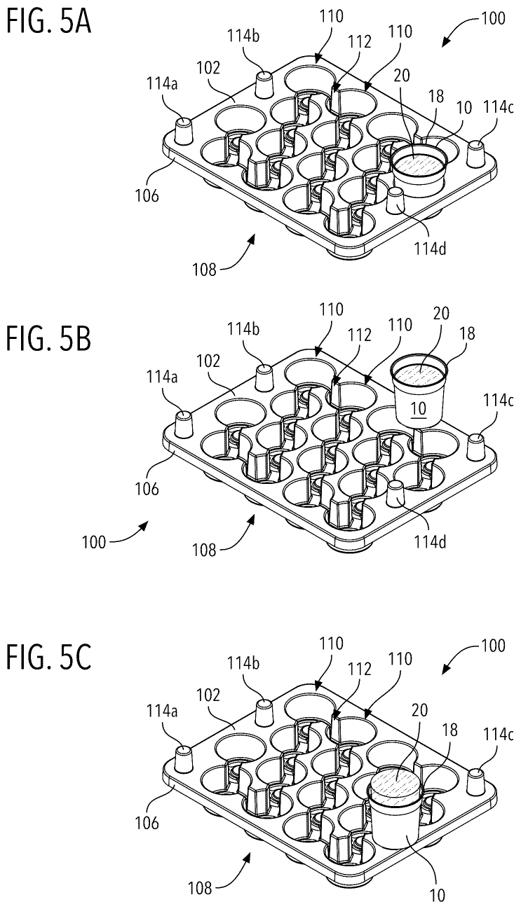

FIGS. 5A through 5C generally illustrate the functionality of the tray shown in FIGS. 1A and 1B;

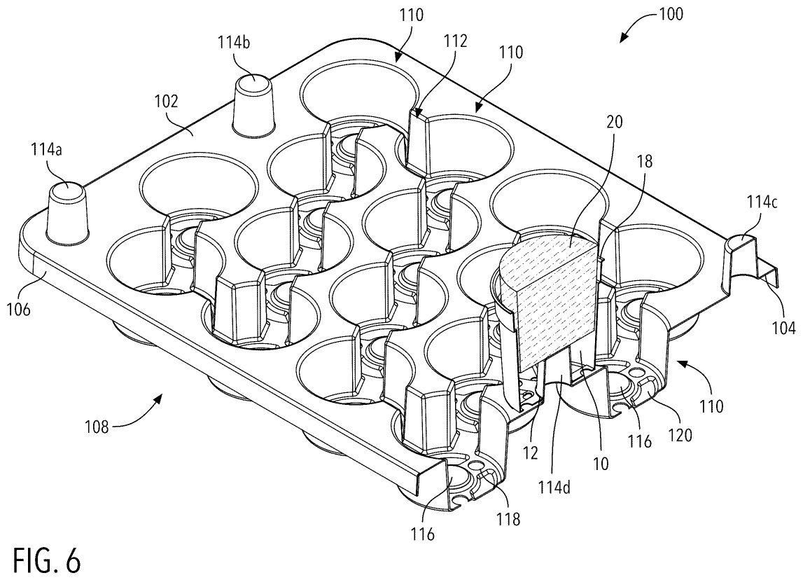

FIG. 6 shows the tray in FIG. 5C with a portion thereof cutaway; and,

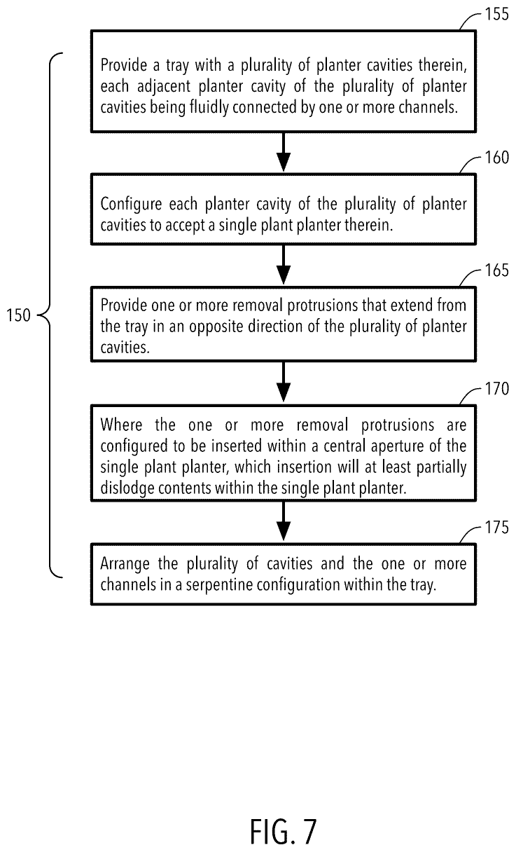

FIG. 7 illustrates a method for transporting single plant planters.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims. Those in the art will understand that any suitable material, now known, or hereafter developed, may be used in forming the present invention described herein.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

It should be noted that the terms “including”, “includes”, “having”, “has”, “contains”, and/or “containing”, should be interpreted as being substantially synonymous with the terms “comprising” and/or “comprises”.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” or “one of:” is used herein.

Adverting now to the figures, FIGS. 1A and 1B generally show perspective views of a planter transport tray having a plurality of single plant planters therein. Planter transport tray 100 has top face 102 and bottom face 104. Lip 106 extends from an external edge of tray 100, specifically in a downward direction. Tray 100 has plurality of cavities 108 disposed within top face 102 and each cavity of plurality of cavities 108 protrudes from bottom face 104. Each of plurality of cavities 108 forms planter cavity 110, and each of planter cavity 110 is designed to hold, at least a portion thereof, single plant planter 10 therein. As shown, single plant planter 10 may have soil 20 therein. It should be appreciated that soil 20 may include one or more of soil, a seedling, seedlings, a root ball, root balls, fertilizer, or nutrients, or other items necessary to facilitate the proper growth of a seedling or plant. In a preferred embodiment, tray 100 includes one or more of protrusion 114 extending or protruding from top face 102. Protrusion 114 is a “removal protrusion” that is configured to assist removal of soil 20 from single plant planter 10, detailed further, infra.

In reference to FIGS. 2A and 2B, tray 100 preferably includes a plurality of channels, e.g., channel 112. Each channel 112 is fluidly connected to one or more planter cavity 110. Generally, each channel 112 is disposed between and connects a pair of adjacent planter cavities of plurality of cavities 108. Channel 112 allows fluid, e.g., water, to travel between a pair of adjacent planter cavities. This design at least reduces, or prevents, overwatering or uneven watering of single plant planters (and their contents) within tray 100, allowing water to flow from a first planter cavity to a second planter cavity, through a channel connecting the first and second planter cavities. For example, if a watering system, or user, only waters a portion of plurality of cavities proximate one of the sides of tray 100 and the watering system, or user, does not water an opposite side of tray 100, water can flow through one or more of channel 112 to one or more of planter cavity 110 that are un-watered or dry.

It should be noted that at least two of tray 100 can be stacked within another of tray 100.

As shown in FIG. 3A, each planter cavity 110 of plurality of cavities 108 and the plurality of channels, e.g., one or more of channel 112, are preferably designed to form a serpentine pattern within tray 100. Notably, the serpentine pattern has a pair of end planter cavities, e.g., end planter cavity 126, and a plurality of connecting planter cavities, e.g., connecting planter cavity 128, within the serpentine pattern and connecting the pair of end planter cavities. End planter cavity 126 is defined by being in fluid connection with one channel 112. Connecting planter cavity 128 is defined by being in fluid connection with a pair of channels 112. In the embodiment shown in FIG. 3A, tray 100 has sixteen planter cavities 110 and fifteen channels 112, in other words, preferably, there is one less channel 112 than the total number of planter cavities 110.

As shown in FIG. 3B, with reference to FIG. 3A, each planter cavity 110 of plurality of cavities 108 includes floor 122. Floor 122 formed by a plurality of components, namely, central protrusion 116 and one or more of arcuate depression 120. Floor 122 also includes one or more of drainage aperture 118. In a preferred embodiment, floor 122 of planter cavity 110 integrates or is monolithic with floor 124 of channel 112.

FIG. 4 is a perspective view of tray 100 shown in FIG. 1A with portions thereof cutaway, illustrating single plant planters 10 within planter cavities 110. When single plant planter 10 is seated within planter cavity 110, central protrusion 116, which protrudes upwardly from floor 122 of planter cavity 110, is at least partially seated within central aperture 12 of floor 16 of single plant planter 10, thereby “closing” central aperture 12, in a non-fluid-tight fashion. Central protrusion 116 acts a barrier to prevent soil 20 from falling through central aperture 12 of single plant planter. Floor 16 of single plant planter 10 rests on floor 122 of planter cavity 110, such that there is a space between floor 16 of single plant planter 10 and arcuate depressions 120. In some embodiments, central protrusion 116 is frustoconical in design, meaning that its outer diameter increases from its topmost surface in the direction towards floor 122. This configuration may create a space between floor 16 of single plant planter 10 and floor 122 of planter cavity 110, as portions of central protrusion 116 have an outer diameter greater than an inner diameter of central aperture 12.

FIGS. 5A through 5C (along with FIG. 6) generally illustrate the functionality of planter transport tray 100 for dislodging contents from single plant planter 10. Not only does planter transport tray 100 allow a plurality of single plant planters 10 to be transported within tray 100, but it also provides a soil dislodging or removal mechanism that aids in dislodging soil 20 from single plant planter 10 without having to rotate, tilt, or invert single plant planter 10. This mechanism is best illustrated when viewed sequentially.

In FIG. 5A, single plant planter 10 is shown seated within planter cavity 110. Tray 100 includes one or more removal protrusions 114a, 114b, 114c, 114d extending from its top face 102, separate from planter cavities 110. When a user wishes to remove the plant, single plant planter 10 is first lifted vertically out of its planter cavity 110.

As shown in FIG. 5B, single plant planter 10, now removed from its holding cavity, is then positioned over one of the removal protrusions, for example, first protrusion 114a. First protrusion 114a is configured to be inserted into central aperture 12 (See FIGS. 4 and 6) of single plant planter 10.

FIG. 5C demonstrates the dislodging action. As single plant planter 10 is pressed down onto removal protrusion 114a, the protrusion passes through a central aperture in floor 16 of planter 10. This applies an upward force to soil 20 and root ball within the planter, effectively dislodging them from the inner walls and floor of the planter. This protruding portion of soil 20 can then be easily gripped by a user, device, or automated system, allowing for the gentle and complete removal of the plant and its root ball from planter 10 without needing to tilt, invert, or squeeze the planter. This mechanism significantly reduces the risk of plant damage and mess.

The dislodging mechanism, as depicted in FIGS. 5A through 6, is specifically designed to keep a plant within single plant planter 10 in an upright orientation at all times during the dislodgement process. The upward force exerted by removal protrusion 114, inserted through central aperture 12, acts directly on soil 20 and root ball from the base, causing the contents to rise without requiring any tilting or inversion of the planter itself. Furthermore, once single plant planter 10 is positioned onto removal protrusion 114, the engagement between protrusion 114 and central aperture 12 can function as a temporary holder. This allows single plant planter 10 to maintain its stable, upright position on protrusion 114 until it is purposefully lifted vertically, thereby disengaging protrusion 114 from the aperture 12. This holding function frees the user's hands for other tasks or facilitates automated handling.

FIG. 6 illustrates a partial cutaway view of tray 100 with single plant planter 10 engaged with removal protrusion 114d, further illustrating how removal protrusion 114d inserts into central aperture 12 of single plant planter 10. This action pushes soil 20 upwards, causing it to extend past opening 18 of single plant planter 10, making it ready for easy extraction. The combination of the specifically designed planter transport tray 100 with its removal protrusions 114, and single plant planter 10 with its central aperture 12, provides an effective and user-friendly system for plant handling, and is especially suited for large-scale industrial and commercial operations.

The method for transporting single plant planters and facilitating their removal, e.g., 150, is also illustrated in FIG. 7 and its associated description references FIGS. 1A through 6. Beginning with step 155 of providing planter transport tray 100. Tray 100 is characterized by having plurality of planter cavities 110 therein, where each adjacent planter cavity 110 of plurality of planter cavities 108 is fluidly connected by one or more channels 112. Channels 112 may be configured in a serpentine pattern, as depicted in FIG. 3A, to optimize fluid distribution.

Next, step 160, each planter cavity 110 of plurality of planter cavities 108 is configured to accept single plant planter 10 therein. This involves the physical design of the cavities 110 to securely hold planters 10 for transport and watering, as shown in FIGS. 1A-2B, and 4. Planter cavities 110 are designed such that single plant planter 10 can be easily placed into and removed from cavity 110.

Subsequently, step 165, the method involves providing one or more removal protrusions 114 that extend from tray 100. Removal protrusions 114 are positioned in an opposite direction of plurality of planter cavities 108, meaning they protrude upwards from top face 102 of tray 100, as visible in FIGS. 1A-2B, and 5A-6. Removal protrusions 114 are not located within planter cavities 110 themselves but are typically positioned adjacent to or between rows of cavities, or along the edges of the tray, providing dedicated points for the plant removal operation.

The critical aspect of the method, step 170, is that one or more removal protrusions 114 are adapted to be inserted within central aperture 12 of single plant planter 10. This interaction, as detailed in FIGS. 5A-6, thereby dislodges contents within single plant planter 10, allowing a user to grab the protruding portion of soil 20 to remove it from single plant planter 10. This two-step process of first lifting the planter from its cavity and then engaging it with a dedicated removal protrusion on the tray significantly improves the ease and safety of plant removal, minimizing plant damage and soil spillage.

In optional step 175, the method may further comprise arranging plurality of cavities 108 and one or more channels 112 in a serpentine configuration within tray 100, as illustrated in FIG. 3A. This configuration aids in efficient water distribution and drainage throughout the tray.

Thusly, the embodiments shown and described are merely exemplary and various alternatives, combinations, omissions, of specific components, or foreseeable alternative components, understood by one having ordinary skill in the art, described in the present disclosure or within the field of the present disclosure, are intended to fall within the scope of the appending claims.

It will be appreciated that various aspects of the present invention and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the claims.

### REFERENCE NUMERALS

Single plant planter
12 Central aperture
14 Drainage apertures
16 Floor
18 Opening
Soil
100 Planter transport tray
102 Top face
104 Bottom face
106 Lip
108 Plurality of cavities
110 Planter cavity
112 Channel
114 Protrusion
114a First protrusion
114b Second protrusion
114c Third protrusion
114d Fourth protrusion
116 Central protrusion
118 Drainage aperture
120 Arcuate depression
122 Floor
124 Floor
126 End planter cavity
128 Connecting planter cavity
150 Method for transporting single plant planters
155 Method step
160 Method step
165 Method step
170 Method step
175 Method step

What is claimed is:

1. A planter transport tray, comprising:
a top face and a bottom face;
a plurality of cavities disposed within the top face and protruding from the bottom face, each of the plurality of cavities forming a planter cavity, the planter cavity having a floor with one or more drainage apertures therein;
a plurality of channels disposed within the top face and protruding from the bottom face, each channel of the plurality of channels connected between two adjacent planter cavities; and,
one or more protrusions disposed within the bottom face and protruding from the top face,
wherein each planter cavity is adapted to accept a single plant planter therein, the single plant planter having a central aperture, the one or more protrusions configured to be inserted into the central aperture of the single plant planter thereby dislodging contents therein away from the central aperture for removal.

2. The planter transport tray recited in claim 1, wherein the plurality of channels fluidly connects the plurality of cavities.

3. The planter transport tray recited in claim 1, wherein each of the plurality of cavities is cylindrical.

4. The planter transport tray recited in claim 1, wherein the one or more protrusions are cylindrical.

5. The planter transport tray recited in claim 1 further comprising:
a lip circumscribing an edge of the tray and extending distally therefrom.

6. The planter transport tray recited in claim 1 further comprising:
a central protrusion arranged within the floor of each planter cavity, the central protrusion arranged to be at least partially inserted within the center aperture of the single plant planter when the single plant planter is seated within the planter cavity.

7. The planter transport tray recited in claim 1, wherein each channel of the plurality of channels has a floor, the floor each channel of the plurality of channels being integrally connected to the floors of a pair of adjacent planter cavities.

8. The planter transport tray recited in claim 6, where the floor of the planter cavity includes a plurality of arcuate depressions circumscribing the central protrusion and protruding from the floor, wherein the one or more drainage apertures are arranged between a pair of arcuate depressions of the plurality of arcuate depressions.

9. The planter transport tray recited in claim 1, wherein each of the plurality of cavities is frustoconical.

10. The planter transport tray recited in claim 1, wherein the one or more protrusions are frustoconical.

11. The planter transport tray recited in claim 5, wherein the lip is angled in a direction away from the plurality of cavities.

12. The planter transport tray recited in claim 1, wherein the one or more protrusions forms a protrusion cavity within the bottom face.

13. The planter transport tray recited in claim 1 configured with one less channel of the plurality of channel than the plurality of cavities.

14. The planter transport tray recited in claim 1, wherein the plurality of channels fluidly connects the plurality of cavities in a serpentine pattern.

15. The planter transport tray recited in claim 1, wherein the plurality of cavities includes a pair of end planter cavities, each of the pair of end planter cavities is fluidly connected to a single channel of the plurality of channels.

16. The planter transport tray recited in claim 1, wherein some of the plurality of cavities are connecting planter cavities, each of the connecting planter cavities is fluidly connected to a pair of channels of the plurality of channels.

17. A method for transporting single plant planters, comprising:
providing a tray with a plurality of planter cavities therein, each adjacent planter cavity of the plurality of planter cavities being fluidly connected by one or more channels;
configuring each planter cavity of the plurality of planter cavities to accept a single plant planter therein; and,
providing one or more removal protrusions that extend from the tray in an opposite direction of the plurality of planter cavities,
wherein the one or more removal protrusions are configured to be inserted within a central aperture of the single plant planter, thereby dislodging contents within the single plant planter.

18. The method recited in claim 17 further comprising:
arranging the plurality of cavities and the one or more channels in a serpentine configuration within the tray.

19. A plant container handling system, comprising:
a tray body having a top surface and a bottom surface;
a plurality of distinct container receiving portions integrally formed with the tray body, each container receiving portion configured to individually hold a plant container; and,
at least one dislodging protrusion extending from the top surface of the tray body, wherein the at least one dislodging protrusion is configured to be inserted into an aperture of a plant container when the plant container is positioned over the dislodging protrusion, thereby at least partially displacing contents within the plant container away from its base.

20. The plant container handling system recited in claim 19, wherein each of the plurality of distinct container receiving portions is fluidly connected to another container receiving portion of the plurality of distinct container receiving portions by one or more channels.
